(19) United States
(12) Patent Application Publication
(10) Pub. No.: US 2019/0327933 A1
(43) Pub. Date: Oct. 31, 2019

(54) METHOD AND ARRANGEMENT FOR DAIRY ANIMAL MANAGEMENT

(71) Applicant: DELAVAL HOLDING AB, Tumba (SE)

(72) Inventors: Conny SVAHN, Tumba (SE); Karol FERENC, Tumba (SE)

(21) Appl. No.: 16/310,698

(22) PCT Filed: Oct. 28, 2016
(86) PCT No.: PCT/SE2016/051062

§ 371 Date: Dec. 17, 2018

(30) Foreign Application Priority Data
Jun. 17, 2016 (SE) 1650859-0

(51) Int. Cl. A01K 1/12; A01J 5/007

(52) U.S. Cl. CPC A01K 1/12; G06Q 50/02; A01J 5/007

(57) ABSTRACT

An arrangement and a method for supporting dairy animal management, with a portable milking unit operable to communicate using short-range wireless communication and a wireless user equipment operable to communicate using short-range wireless communication, where the portable milking unit provides data related to a milking session of a specific dairy animal directly to the wireless user equipment over a short-range wireless link, and the wireless user equipment receives the data directly from the portable milking unit over the short-range wireless link. The received data includes information indicative of a milk yield of the specific dairy animal during the milking session, and the wireless user equipment stores the received data in a memory, retrieves previously stored data related to one or more previous milking sessions, and provides a representation of the received data and the retrieved previously stored data on a display.

### TECHNICAL FIELD

The invention relates to a method and an arrangement for supporting dairy animal management.

### BACKGROUND

A highly producing dairy cow can produce 50 litres of milk every day. In order for the dairy cow to produce 50 litres of milk, it has to move about 25,000 litres of blood through its udder. This is an achievement in parity with that of a human running a marathon. By such a comparison, it may easily be understood that the cow must be in good condition to be able to produce large amounts of milk every day. Naturally, this is true also for other types of dairy animals, such as buffalos, goats and sheep.

As today's dairy industry is highly competitive, it is more important than ever for milk producers, such as dairy farmers, to keep informed about the production and welfare of their herd. When having access to the right information, it becomes possible to manage the dairy animals in a good and efficient way.

Modern large dairy farms can have herds of more than 10 thousand animals. However, the main part of the world's milk production takes place in much smaller farms, having herds of less than 50 animals. For example, a majority of the dairy animals in India, which is one of the world's leading milk producing countries in terms of volumes of milk, are kept in herds of 2-8 animals.

Many large dairy farms are equipped with automatic milking systems, AMSs, involving robot assisted milking of the dairy animals. There are different types of AMS solutions. For example, there are fully automated rotary milking systems, where dairy animals are milked automatically, i.e. robot assisted, while standing on a rotating platform. In such systems, one or more robots are typically located either on the outside of the outer circumference of the platform, or inside of the inner circumference of the platform, depending on how the animals are oriented on the platform during milking. There are also other types of AMSs, where dairy animals may enter a stationary milking station, e.g. when determined to have a milking permission. On dairy farms with AMS systems, detailed information about the milking sessions can typically be seen in real time on displays connected to the highly advanced, and often expensive, milking equipment, and data can also be collected by the same highly advanced milking equipment and be supplied to a herd management system on a computer. Automatic milking systems are typically used together with so-called “loose-housing”, and the dairy animals are brought to, or come voluntarily to the so-called milking parlor or milking station.

Even though loose-housing systems become more and more common, the stall barn or stanchion barn animal housing type is still widely used in many parts of the world. In a stall barn, each animal is tied up in a stall for resting, feeding, milking, and watering. This type of housing is, by tradition, often used in countries with a cold climate, and also by farmers having small herds and/or limited access to pastures. Stall barn milking may be used for whole herds or for parts of herds, such as e.g. for milking sick cows or older cows that do not fit a main automatic milking system used for the rest of the herd.

Stall barn milking equipment typically comprises portable milking units, PMUs, which can be moved to a desired milking position and thus also between milking positions. One type of PMUs are temporarily connected to milk and vacuum connectors during milking at different positions in a stall barn. For example, PMUs may be movable along an over-head rail arrangement to different milking positions in a stall barn, and thus each PMU could be used for milking dairy animals in a plurality of different milking positions in the stall barn. Another type of PMUs are not connected to vacuum or milk connectors provided e.g. in a barn, but include a vacuum unit and a milk container, such as a bucket, in addition to comprising a cluster of teat cups, etc. Such PMUs are often referred to as “bucket milking units”. Automatic milking systems are typically not used in stall barns.

FIG. 1 illustrates an example of a portable milking unit, PMU, configured for use in a stall barn. The PMU in FIG. 1 comprises a cluster of teat cups 101, a user interface 102, vacuum and milk hoses 103 and a hook 104 for suspension. FIG. 1 also comprises two separate illustrations of exemplifying user interfaces 102. The PMU in FIG. 1 hangs, by the hook 104, from a rail 105 arranged in the barn, and can be moved/slide along the rail. The hoses are manually connected to vacuum and milking connectors arranged at different milking positions, and are thereby connected to delivery pipes which run parallel to the rail. The PMU may also comprise other components necessary for milking, which are not explicitly described herein, such as energy supply. For example, the PMU may also be connected to an energy supply when being manually connected, e.g. by means of a multi-purpose integrated energy/vacuum connector.

A PMU may further comprise an identification device for identification of a dairy animal present at a milking position. The PMU may further comprise a milk meter for measuring the milk drawn from the dairy animal. Basic milk meters having limited accuracy may alternatively be denoted or referred to as milk indicators. An example of a PMU comprising a milk indicator is the DeLaval product MU-Blue. More advanced milk meters may provide milk yield information with high accuracy, such as flow rate per time unit for a milking session and/or a quantity of milk derived during the milking session. Examples of PMUs comprising such advanced milk meters, which are approved by the International Committee for Animal Recording (ICAR) and Dairy Herd Improvement Association, (DHIA), are the DeLaval products MU480 and MU486, It is also possible with some currently available advanced PMUs, such as the mentioned MU486, to determine a conductivity value of the milk, a colour of the milk (using RGB analysis) and other milk parameters. The colour analysis can be used e.g. to detect the presence of blood in the milk.

The data produced by the PMU can be communicated, via wire or wirelessly via Bluetooth, to a local network arranged in the barn to enable the farmer to better manage his herd by use of a herd management system installed on the farm.

Such a local network is illustrated in FIG. 2. The local network in FIG. 2 comprises a system controller 201, responsible for the control of the dairy farm system. The system controller 201 is typically connected to a PC 202, e.g. in an office in the barn. The connection between the system controller 201 and the PC 202 may be provided by an Ethernet cable 203:1. The local network further comprises at least one transceiver 204, sometimes denoted Wireless Unit, WU, for receiving Bluetooth signals from portable milking units 205:i. The local network may comprise further nodes 206 dedicated for other tasks than milking, such as e.g. a feeding station controller, a cleaning system, a vacuum supply system and/or a cooling tank. The system controller is connected to the transceiver 204 and other functional units 206 by a data bus 203:2, such as a so-called Controller Area Network, CAN, bus, arranged in the barn. The system controller 201 may retrieve and process information from the units 204, 206, to which it is connected via the data bus, and management information or instructions may be forwarded to the PC 202.

Each of the PMUs 205:i are connected to the system controller 201 via the transceiver 204, and may thus provide information on cow identity and milk yield to the system controller 201, when the PMU comprises equipment for measuring milk yield and obtaining animal IDs.

However, many farmers cannot afford or do not want to take the cost of a herd management system or the installation of a local network in the barn. These farmers will have a great disadvantage when competing with other dairy farmers having access to such systems and networks.

### SUMMARY

It is desirable to access strategic information about the animals in a herd of dairy animals in order to manage them well. It is further desirable to access such strategic information although not having access to a complete herd management system or to local networks.

As realized by the inventors, portable milking units, PMUs, are very often used in so-called stand-alone mode. That is, even though the PMUs are operable to communicate with a local network, via wire or wirelessly, this possibility is not exploited. There may be many reasons for this, but one reason is certainly the investments necessary to provide and maintain a local network infrastructure and further the cost of a herd management system. However, the inventors realize that most farmers have access to a Smart Phone, or may at least be willing to take the, often modest, investment of a Smart Phone, since such a device is useful for many different purposes.

This invention supports management of dairy animals in stall barns or other housings or environments where portable milking units, PMUs, are used. Embodiments of the invention do not require a local network, and for many implementations, even no network coverage of any kind. However, there is nothing hindering use of the invention also in scenarios with an existing local network. Embodiments described herein provide a low cost and low complexity alternative and/or complement to existing herd management systems. The invention enables immediate access to dairy animal related information by use e.g. of a standard Smart Phone.

According to a first aspect, a method is provided, which is to be performed by an arrangement comprising a PMU, operable to communicate using short-range wireless communication and a WUE, operable to communicate using short-range wireless communication. The method is suitable for supporting dairy animal management. According to the method, the PMU provides data related to a milking session of a specific dairy animal directly to the WUE over a short-range wireless link. The WUE receives the data directly from the PMU over the short-range wireless link. The received data comprises information indicative of a milk yield of the specific dairy animal during the milking session. The method further comprises the WUE storing the received data in a memory, and further retrieving previously stored data related to one or more previous milking sessions. The method further comprises the WUE providing a representation of the received data and the retrieved previously stored data for display on a display of the WUE.

According to a second aspect, an arrangement is provided, which comprises a PMU, operable to communicate using short-range wireless communication and a WUE, operable to communicate using short-range wireless communication. The arrangement is suitable for supporting dairy animal management. The arrangement is configured to provide, by the PMU, data related to a milking session of a specific dairy animal directly to the WUE over a short-range wireless link. The arrangement is further configured to receive, by the WUE, the data directly from the PMU over the short-range wireless link. The received data comprises information indicative of a milk yield of the specific dairy animal during the milking session. The arrangement is further configured to store, by the WUE, the received data in a memory; and to retrieve, by the WUE, previously stored data related to one or more previous milking sessions. The arrangement is further configured to provide, by the WUE, a representation of the received data and the retrieved previously stored data for display on a display of the WUE.

According to a third aspect, a computer program is provided, which comprises instructions which, when executed on at least one processor, cause the at least one processor to carry out the actions associated with the PMU in the method according to any of claims 1-7.

According to a fourth aspect, a computer program is provided, which comprises instructions which, when executed on at least one processor, cause the at least one processor to carry out the actions associated with the PMU

According to a fifth aspect, a carrier is provided, containing a computer program according to the third or fourth aspect, wherein the carrier is one of an electronic signal, optical signal, radio signal, or computer readable storage medium.

### BRIEF DESCRIPTION OF DRAWINGS

The foregoing and other objects, features, and advantages of the technology disclosed herein will be apparent from the following more particular description of embodiments as illustrated in the accompanying drawings. The drawings are not necessarily to scale, emphasis instead being placed upon illustrating the principles of the technology disclosed herein.

FIG. 1 shows an exemplifying portable milking unit, according to the prior art.

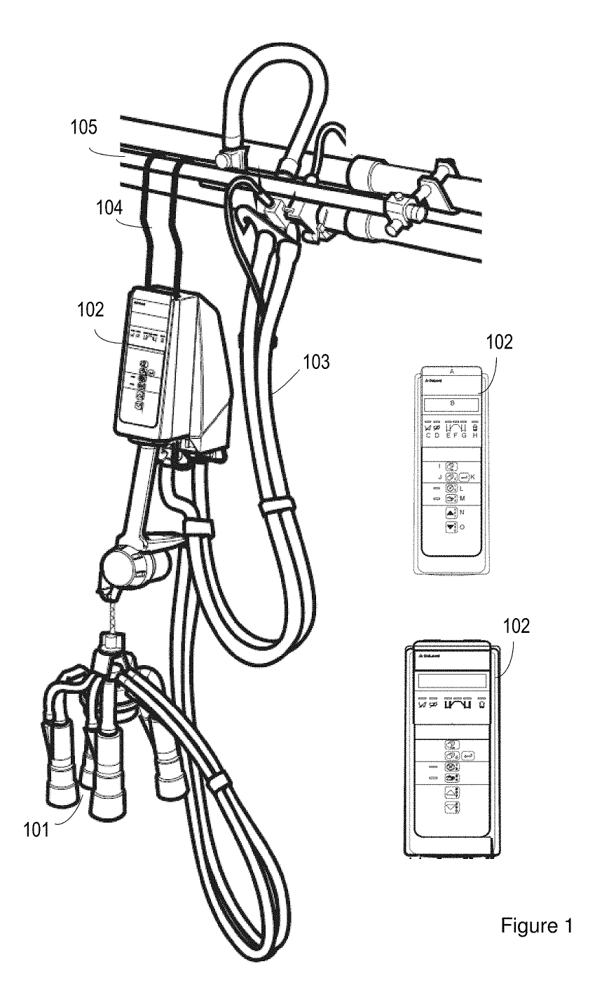

FIG. 2 is a schematic block diagram illustrating a local network in a barn, according to the prior art.

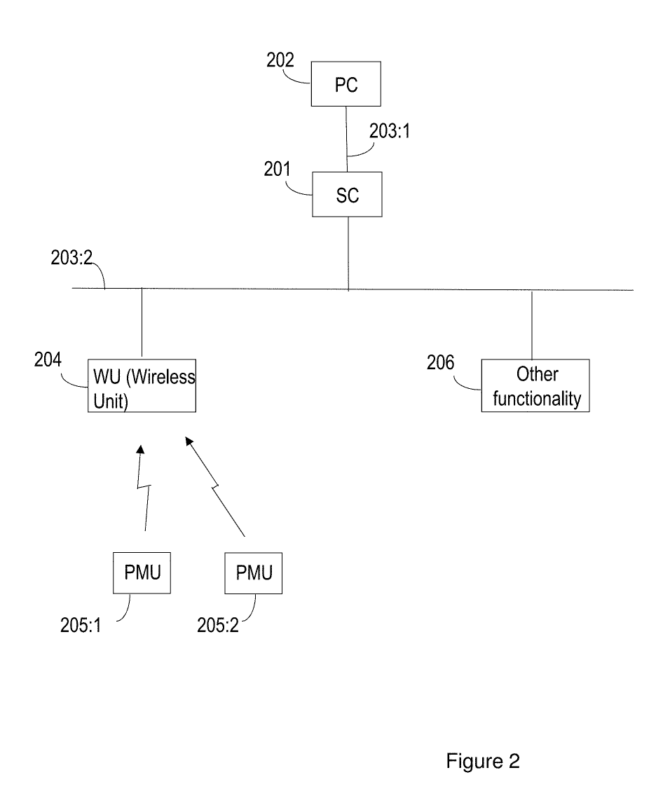

FIG. 3-4 are flowcharts illustrating exemplifying methods performed by a network node or an arrangement according to different embodiments.

FIG. 5 is a signaling diagram illustrating signaling between a WUE and a PMU according to an exemplifying embodiment.

FIG. 6 is a signaling diagram illustrating signaling between a WUE, a PMU and a remote server, according to an exemplifying embodiment.

FIGS. 7a-7b are schematic illustrations of communication between different units according to exemplifying embodiments.

FIGS. 8a-8b are diagrams illustrating different possible results associated with representations of received data and retrieved previously stored data provided for display according to exemplifying embodiments.

FIGS. 9a-9c are schematic block diagrams illustrating different implementations of a wireless user equipment, WUE according to exemplifying embodiments.

FIGS. 10a-10c are schematic block diagrams illustrating different implementations of a portable milking unit, PMU, according to exemplifying embodiments.

### DETAILED DESCRIPTION

Portable milking units, PMUs, are used in many dairy farms today, all over the world. Although the PMUs are often capable of providing important information, typically by using the so-called Bluetooth communication standard, this possibility is not utilized. Typically, no local network or infrastructure is provided for obtaining and handling information provided by the PMUs. Instead, the PMUs are used in stand-alone mode, i.e. only for doing the job of milking a number of dairy animals a number of times per day. Thereby, valuable information, which could be used for managing dairy animals, e.g. to increase production, is overlooked.

Below, embodiments of a method will be described with reference to drawings 3-7. The embodiments are to be performed by an arrangement comprising a portable milking unit, PMU, operable to communicate using short-range wireless communication and a Wireless User Equipment, WUE, operable to communicate using at least short-range wireless communication. The WUE may preferably also be operable to communicate using a long-range wireless communication system/standard, but this is not a requirement for all implementations. The short range wireless communication is preferably performed using Bluetooth, but could alternatively be performed using other types of short-range direct links.

The PMU preferably comprises a milk meter measuring e.g. a milk yield and possibly a milk flow during a milking session; an animal identification unit, for obtaining an animal identity; and a local dock. Some PMUs may also comprise a sensor for measuring the conductivity of milk derived from an animal, and/or a sensor for detecting presence of blood in milk derived from an animal. However, some embodiments of the invention are also applicable for very basic PMUs, sometimes referred to as “bucket milking units”, when such units are provided with means for wirelessly providing milking session related data, such as milk yield, to a WUE. The PMU should be able to provide information indicative of a milk yield of a specific animal. Examples of such information is milk yield and milk flow, as previously mentioned, e.g. flow rate per time unit for a milking session and/or a quantity of milk derived during a milking session. This information could be accompanied by time information related to the milking session, such as duration of the milking session, starting time and/or ending time of the milking session, time for peak flow, etc. This time information could be relative or absolute. The information indicative of a milk yield could be delivered during and/or after the milking session, e.g. continuously during the milking session or in association with the end of the milking session.

The WUE is preferably a so-called “Smart Phone”, but could also be e.g. a small tablet. Smart Phones and tablets are well known and have been on the market for many years. Smart Phones are typically operable for short-range communication using Bluetooth and wi-fi, and also operable for long-range communication using a 2G, 3G and/or 4G standard, such as e.g. GSM, WCDMA and/or LTE. For embodiments of the invention which do not utilize long-range communication, the long-range functionality of the WUE may be disabled or non-existing, e.g. the Smart Phone could be put in flight mode, or not be provided with a SIM-card, or corresponding.

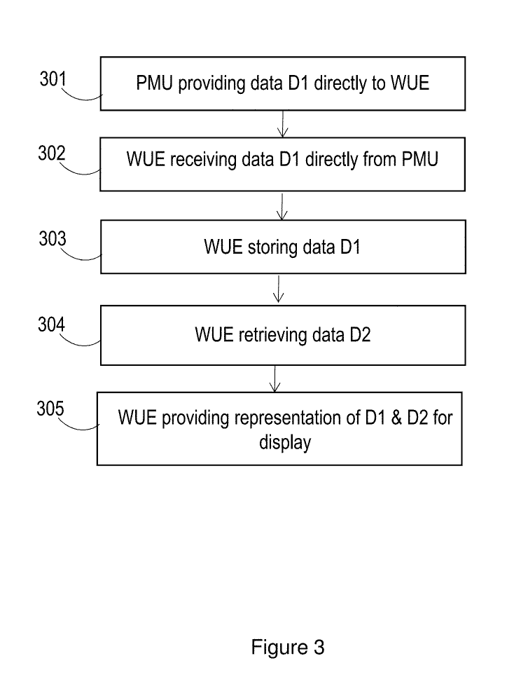

FIG. 3 shows an exemplifying method embodiment which is to be performed by an arrangement of the type described above, comprising a PMU and a WUE. The method illustrated in FIG. 3 comprises that the PMU provides 301 data, D1, related to a milking session of a specific dairy animal directly to the WUE over a short-range wireless link, e.g. using Bluetooth. By “directly” is meant that the information is not provided to the WUE via some local network or via any long-range communication network (but directly). The method further comprises that the WUE receives 302 the data, D1, (provided by the PMU) related to a milking session of a specific dairy animal directly from the PMU over the short-range wireless link. The provided and received data, D1, may be organized as, or comprised in, a milking report, and comprises at least information indicative of a milk yield of the specific dairy animal during the milking session.

Preferably, the data further comprises an identifier of the specific dairy animal obtained by the PMU, and also time information related to the milking session, such as time of day when starting and/or completing the milking session, and even a momentary milk flow per time unit, However, for embodiments for the most basic types of PMUs, an identity of the specific dairy animal may be indicated by a user directly into the WUE, and time information may be associated with or assigned to the data D1 by the WUE, based on an internal time reference of the WUE, e.g. upon receiving of the data.

The method illustrated in FIG. 3 further comprises that the WUE stores 303 the received data, D1, in a memory, and that the WUE retrieves 304 previously stored data, D2, related to one or more previous milking sessions from a memory. The method further comprises that the WUE provides 305 a representation of the received data D1 and the retrieved previously stored data, D2, for display on a display of the WUE. The memory in which the data D1 is stored, and the memory from which the data, D2, is retrieved may be a local memory in the WUE. Use of a local memory is beneficial for cases where the WUE is not reliably connected to any communication network. The data D1 and/or data D2 could alternatively or in addition be stored in a remote server. In such cases, the action “storing the received data in a memory”, performed by the WUE comprises to provide the received data, D1, to a remote server for storage. Correspondingly, the action “retrieving data D2 from a memory” then comprises receiving the data D2 from a remote server, e.g. upon request or in response to storing the data D1. The providing of data to a remote memory/server may be accomplished e.g. by transmission of the data over a long-range wireless communication system. In case the WUE has current access to a wi-fi network, the providing could alternatively be performed via said wi-fi network.

The representation of the received data D1 and the retrieved previously stored data, D2, provided for display, may comprise coordinates composed of or comprising a milk yield or flow value and a time value. Thereby, the yield or flow of the current milking session can easily, and directly, be evaluated against the milk yield or flow, from the same specific animal, during a preceding milking session or set of preceding milking sessions. The milk yield or flow value may be an array of values comprising information from both D1 and D2. Alternatively or in addition the representation could comprise a difference between the data D1 and the data D2.

In embodiments where the milk flow is measured by the PMU and provided to the WUE, the milk flow per time unit for a current milking session can be compared to the corresponding milk flow per time unit for a previous milking session. If a dairy animal releases its milk more slowly during a current milking session than a previous one, this may be an indication e.g. of a developing udder infection, which then could be immediately investigated and attended to by a herdsman.

Performing of an embodiment of the method described herein enables e.g. immediate access to important information related to milking of a dairy animal. A herdsman carrying the WUE may thus access information on a current milk yield of a dairy animal in relation to a previous milk yield when standing in the barn next to the animal, during or immediately after milking of the dairy animal. The Smart Phone would preferably be her/his “currently in use” personal Smart Phone, but could alternatively be some old Smart Phone degraded from regular continuous use to use in (high-dirt-risk) barn environments. All sorts of analysis may be performed on the data D1 obtained from the PMU and the data D2 retrieved from a memory, and the results may be provided for display. The herdsman can thus keep informed as he/she works with milking of the dairy animals e.g. in a stall barn.

The retrieved data D2 would typically comprise data related to the specific dairy animal associated with the data D1. However, the data D2 could also comprise data related to other animals in the herd, such as e.g. a herd average per milking session including or excluding the specific animal associated with the data D1. A user of the WUE will thereby have an immediate possibility, not only to evaluating the milk production (yield) over time for a specific animal, but also to evaluate, e.g. by comparing graphs, the milk yield over time in relation to the yield over time for other animals in the herd, such as e.g. average group or herd performance. Dairy animals could immediately, while standing in the barn, be evaluated and compared with respect to e.g. total milk production (yield); average milk production, e.g. per session or per selected time interval; Milk flow (for PMUs providing milk flow information); milking time; milking time per session (for PMUs providing timing information) and session conductivity (for PMUs providing information about conductivity).

That is, by using an embodiment of the method described above, milk yield and other aspects of different animals during different milking sessions and time periods may be immediately analyzed and compared. All that is required is a PMU and a WUE configured to perform an embodiment of the method. Thereby, embodiments of the invention enables dairy animal management by simple means, also in lo-tech environments, e.g. without a computer, a local network or network coverage.

In case the PMU comprises sensors for measuring milk conductivity and/or detecting presence of blood in milk, the data, D1, provided by the PMU and received by the WUE may further comprise an indicator of the amount of blood comprised in milk from the milking session, and/or an indicator of the conductivity of milk from the milking session. This information may be analyzed and compared to reference values, e.g. derived from a memory, and an alarm may be triggered in the WUE e.g. when presence of blood is detected. A generalized method related to alarms is illustrated in FIG. 4.

FIG. 4 shows an exemplifying method performed by an arrangement comprising a PMU and a WUE, as described above. The method in FIG. 4 comprises, in analogy with the method in FIG. 3, that the PMU provides 401 data, D1 directly to the WUE via a wireless short-range link, and the WUE receives 402 the data provided by the PMU. The method further comprises that when an indicator (I_D1) comprised in, or derived from, the data, D1, received by the WUE is determined 403 to meet a threshold T, an auditory, visual and/or tactile alarm signal may be triggered 404 to be presented by the WCD. By “meeting a threshold” is meant fulfilling a criterion related to the threshold value, such as: being equal to, exceeding or falling below the threshold value. Which of the criteria that is used will depend on how the threshold is formulated. The determining of whether the indicator meets a threshold could be performed by the WUE, but could alternatively be performed in another node, such as a remote server, for embodiments involving communication with a remote server.

A specific type of alarm could be configured to be connected to a distinct sound, light or vibration, which may allow a herdsman to identify the type and/or seriousness of a triggered alarm. In addition to alarms for presence of blood or anomalies in milk conductivity, an alarm for anomalies in milk yield could be implemented, such as triggering an alarm when the milk yield is a certain amount lower than an expected milk yield, and/or when a milking time is shorter than an expected milking time. The expected milk yield or milking time of a dairy animal may be determined based on data from previous milking sessions or be retrieved as a predefined reference value e.g. from a memory. One or more thresholds, Tᵢ, for each of the different alarm types may be predetermined and be retrievable from a memory.

Further, an indication of an alarm incident may optionally be stored 405 in association with the received data, D1. That is, an indication of a triggered alarm may be stored together with a reference to the stored data, D1; or, the indication of an alarm could be stored together with D1, such that the information is linked. The benefit of this is e.g. that a correlation between alarms and other parameters, such as milk yield, milk conductivity or period of lactation, can be derived.

Further, the method may optionally comprise that the WUE obtains 406 a confirmation from a user of the WUE having observed the alarm, and may also comprise storing an indicator of said confirmation in association with the received data Dl. Thereby, alarms and confirmations of alarms may be associated to a specific dairy animal and milking session for later analysis.

When the indicator comprised in, or derived from, the data, D1, received 402 by the WUE is determined 403 not to meet the threshold T, regular operation may be continued 407 and no alarm is triggered.

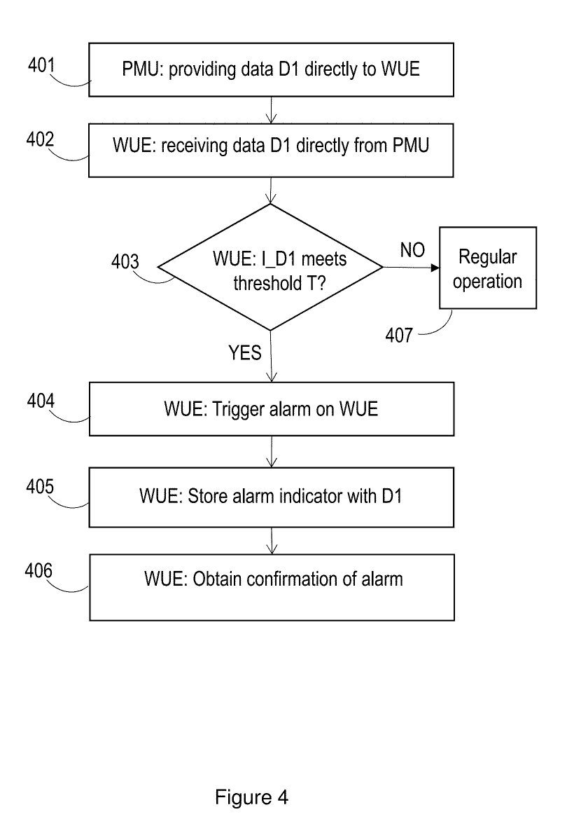

The method embodiments described herein may be further improved by addition of a time related feature, which is illustrated in FIG. 5. FIG. 5 is a signaling diagram illustrating signaling between a WUE 501 and a PMU 502, i.e. within an arrangement as described above. The actions performed by the WUE 501 and PMU 502 are also illustrated in the figure. The signaling diagram in FIG. 5 illustrates an embodiment where the PMU 502 requests 506 a time reference from the WUE 501, by sending a request 503 for a time reference to the WUE. Further, the WUE receives 507 the request 503 from the PMU, and provides 508, in response to the received request 503, a time reference 504 derived from a local clock of the WUE, to the PMU. The PMU receives 509 the time reference 504 provided by the WUE, and then the PMU includes time information in the data, D1 505, provided 512 to the WUE 501, where the time information is based on the received time reference 504. The request 503 may be sent e.g. before the PMU starts performing 510 a milking session, and/or during or after performing 510 a milking session. More than one request 503 may be sent. One advantage of the PMU requesting and receiving a time reference from the WUE is that the PMU will thereby have access to a very precise time reference, without the need to comprise an expensive high-quality internal clock. WUEs, such as Smart Phones, typically comprise very exact internal clock circuits. Thereby, the data provided by the PMU can be linked to very precise time references, which enables detailed analysis of e.g. milk flow per time unit and over time, although the PMU only comprises a “less precise” clock, or even no clock at all. An internal clock of the PMU may be calibrated based on time references obtained from the WUE,

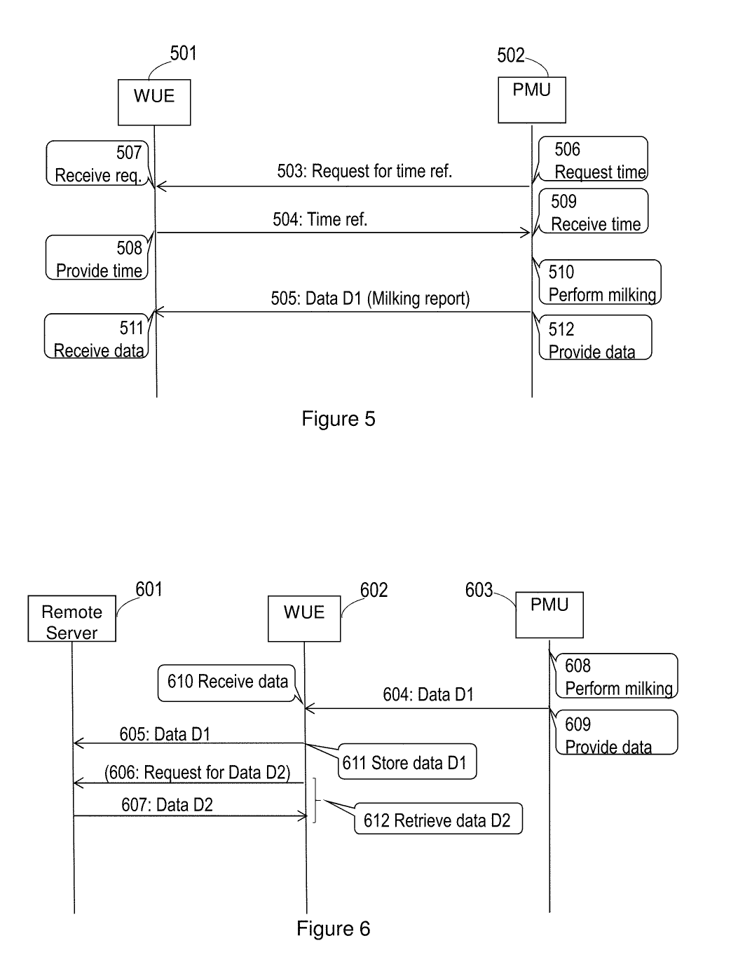

FIG. 6 is a signaling diagram illustrating the signaling performed by an arrangement comprising a WUE 602 and a PMU 603 in an embodiment where the data D1 is stored in a remote server 601 and the data D2 is retrieved from a remote server 601. The remote server may be implemented as a so-called cloud solution, or virtual machine, on one or more physical machines, which may be located in different places and/or countries. The WUE 602 may communicate with the remote server 601 via a wireless Internet connection, via a long-range communication system and/or a wi-fi connection, depending on what is available. The PMU 603 performs 608 milking and provides 609 data, D1 604, to WUE 602, which receives 610 the data D1, just as described in previous embodiments. When the WUE 602 is to store 611 the data D1, the data, D1 605, is provided to the remote server 601. The data D1 604 and the data D1 605 may be assumed to be the same data, but it may be differently packetized, and therefore it is indicated by separate reference numbers. The WUE 602 further retrieves 612 data, D2, from the remote server 601. In FIG. 6, this is illustrated as that the WUE 602 sends a request 606 for data D2 to the remote server, and then receives the data, D2 607, from the remote server. However, alternatively, the remote server may be configured to provide the data, D2 607, in response to receiving the data, D1 605, in which case an explicit request 606 is not required.

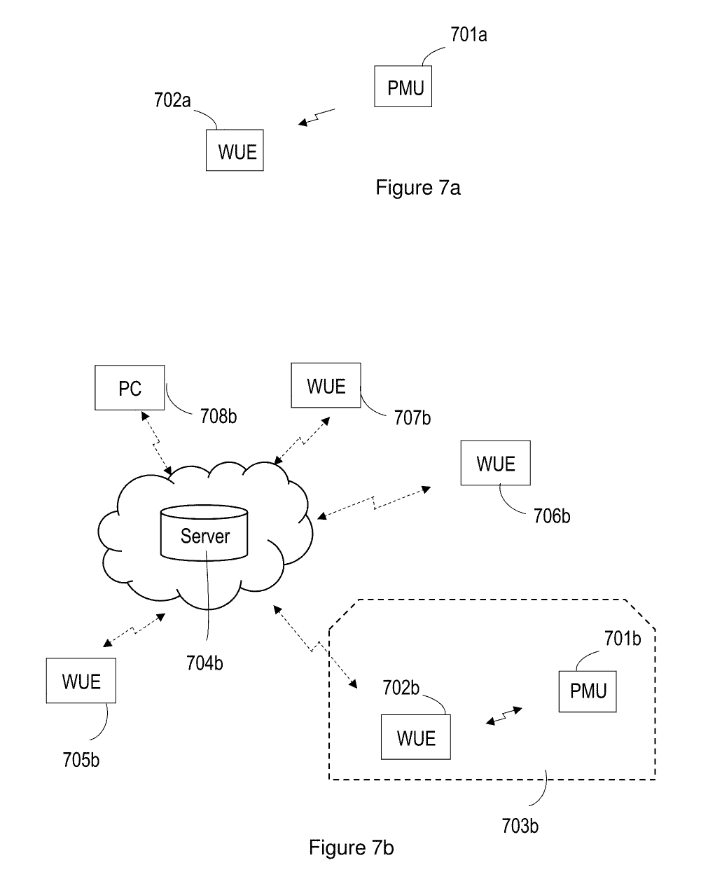

FIGS. 7a and 7b show schematic illustrations of communication taking place when applying different embodiments of the invention. FIG. 7a shows a scenario where a PMU 701a provides information wirelessly to a WIDE 702a. FIG. 7b shows a scenario where a PMU 701b provides information to a WUE 702b, and vice versa. For example, the WUE 702b may provide a time reference to the PMU 701b. In FIG. 7b, the PMU and WUE are illustrated as located in a stall barn 703b. Further, the WUE 702b communicates with a remote server 704b. For example, the WUE 702b may provide data, received from the PMU 701b, to the remote server 704b for storage, and/or obtain previously stored data from the remote server 704b, The remote server 704b may also provide information to other wireless or stationary units 705b-708b.

The storing of data in a memory in a remote server has many advantages. For example, small herd milk producers, e.g. in India, could give access to parts of the stored data to governmental milk agencies, which could provide adequate advice to the milk producers based on their data. This could be expressed as enabling central dairy animal management (e.g. advice from professionals) for farmers not having a local herd management system, or having limited knowledge of how to manage dairy animals based on the acquired information. Applications and interfaces for such purposes could be supplied on the remote server. Further, milk producers themselves and persons which they decide to give access could access the stored data from a number of different platforms, such as browsers or other interfaces on PCs, tablets or WUEs other than the one receiving the data from the PMU, e.g. as illustrated in FIG. 7b.

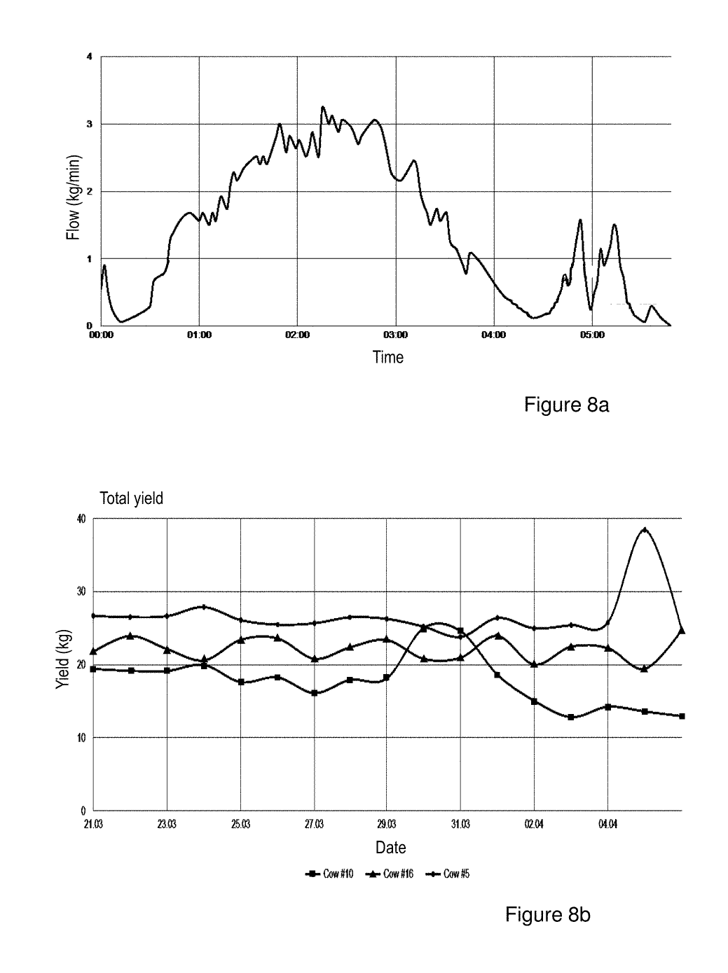

FIG. 8a shows a graph of a milk flow, in kg/min, from a dairy animal over time during a milking session, the graph being based on parts of a representation provided for display by a WUE. Such detailed milk flow data may be provided to a WUE by PMUs having advanced milk meters. Embodiments of the invention enable immediate analysis of such flow graphs on a WUE in environments lacking e.g. any network coverage, which is very beneficial. The flow graph could be compared with flow graphs from previous milking sessions and/or other reference data, which is also very beneficial.

FIG. 8b shows a graph of total milk yield, in kg, over time (per day) for three different dairy animals of a herd. A similar graph showing milk yield per milking session could also be derived. Such data enables analysis of a milk yield of a dairy animal in comparison with previous yields/results of the dairy animal, and in comparison with yields/results of other herd animals,

Method embodiments described herein could further comprise that the WUE obtains, retrieves or receives, data related to one or more geographically remote milking sessions from a remote server. By “geographically remote” is here meant milking sessions performed in other farms than the farm in which the method is performed. It could be a neighboring farm or a farm in another country. Thus, a representation of said obtained reference data could be provided for display on the display of the WUE as a reference, enabling evaluation of the milking session in relation to the one or more geographically remote milking sessions. Thereby, a dairy farmer could get immediate benchmarking, e.g. in relation to one or more selected dairy farms.

The methods and techniques described above may be implemented in an arrangement comprising a Portable Milking Unit, PMU, and a Wireless User Equipment, WUE, as previously described. The WUE and the PMU comprised in the arrangement will be further described below. At least when the short-range communication between the WUE and the PMU is to be based on a Bluetooth standard, the units should be configured to be operable to be paired with each other. Although Bluetooth is a preferred alternative, due to its simplicity, other similar standards could be used for the short-range communication between the WUE and the PMU, such as the so-called “Wi-Fi Direct” (Wi-Fi P2P). The units should in such case support this other standard and be configured in accordance with that standard. Other types of short-range communication could also be used, based on e.g. Infrared light, IR, or microwave links.

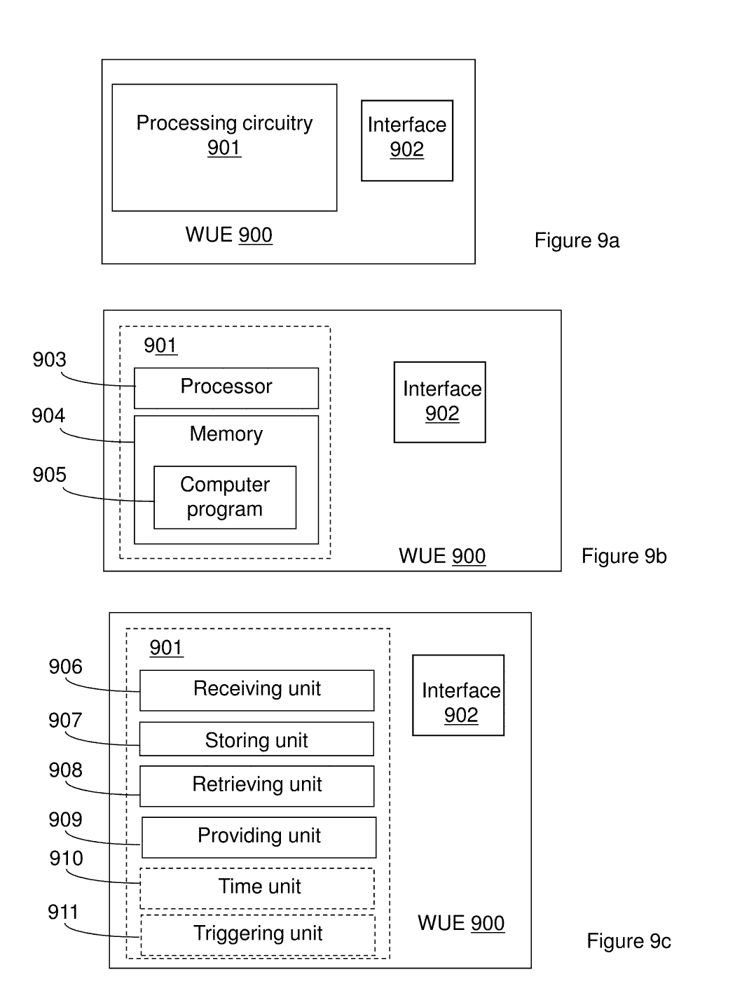

WUE, FIGS. 9a-9c

An exemplifying embodiment of a WUE comprised in the arrangement is illustrated in a general manner in FIG. 9a. The WUE may with advantage be a so-called “Smart Phone”, which operable to communicate is at least using short-range wireless communication, such as Bluetooth, and typically also operable to communicate in a wireless communication network. The WUE 900 is configured to perform the actions associated with a WUE of at least one of the method embodiments described above with reference to any of FIGS. 3-7. The WUE 900 is associated with the same technical features, objects and advantages as the previously described method embodiments. The WUE will be described in brief in order to avoid unnecessary repetition.

The WUE may be implemented and/or described as follows:

The WUE 900 comprises processing circuitry 901 and a communication interface 902. The processing circuitry 901 is configured to cause the WUE 900 to receive, directly from a PMU 1000, over a short-range wireless link, data related to a milking session of a specific dairy animal. The WUE 900 is caused to receive data comprising information indicative of a milk yield of the specific dairy animal during the milking session. The processing circuitry 901 is further configured to cause the WUE 900 to store the received data in a memory, and further to retrieve, from a memory, previously stored data related to one or more previous milking sessions e.g. of the specific dairy animal. The processing circuitry 901 is further configured to cause the WUE 900 to provide a representation of the received data and the retrieved previously stored data for display on a display of the WUE. The providing of a representation should enable that received data and the retrieved previously stored data may be displayed simultaneously, and/or enable that a relation between the received data and the retrieved previously stored data may be displayed.

The communication interface 902, which may also be denoted e.g. Input/Output (I/O) interface, includes an interface for sending data to and receiving data from other nodes or entities, such as a PMU 1000, and base stations in a wireless communication system.

FIG. 9b shows an embodiment of the processing circuitry 901 which comprises a processing device 903, such as a general-purpose microprocessor, e.g. a CPU, and a memory 904, in communication with the processing device, that stores or holds instruction code readable and executable by the processing device. The instruction code stored or held in the memory may be in the form of a computer program 905, which when executed by the processing device 903 causes the WUE 900 to perform the actions in the manner described above.

An alternative implementation of the processing circuitry 901 is shown in FIG. 9c. The processing circuitry here comprises a receiving unit 906 for causing the WUE to receive, directly from a PMU 1000, over a short-range wireless link, data related to a milking session of a specific dairy animal. The processing circuitry further comprises a storing unit 907, for causing the WUE 900 to store the received data in a memory. The processing circuitry further comprises a retrieving unit 908, for causing the WUE 900 to retrieve, from a memory, previously stored data related to one or more previous milking sessions. The processing circuitry further comprises a providing unit 909 for causing the WUE 900 to provide a representation of the received data and the retrieved previously stored data for display on a display of the WUE.

The processing circuitry 901 could comprise more units configured to cause the WUE to perform actions associated with one or more of the method embodiments described herein. For example, the processing circuitry 901 could comprise a time unit 910 for providing a time reference derived from a local clock of the WUE to a PMU 1000, e.g. upon the receiving of an explicit or implicit request for such a time reference. The processing circuitry 901 could alternatively or in addition comprise a triggering unit 911 for causing the WUE 900 to trigger an auditory, visual and/or tactile alarm signal to be presented. This, and other tasks, could alternatively be performed by one of the other units.

The WUE 900 may be assumed to comprise further functionality, for carrying out regular WUE functions.

The foregoing description of a WUE 900 is not intended be limiting. The processing circuitry may also be implemented by other techniques known in the art, such as, e.g., hard-wired transistor logic or application-specific integrated circuits arranged in a manner sufficient to carry out the actions of the WUE 900 as described above.

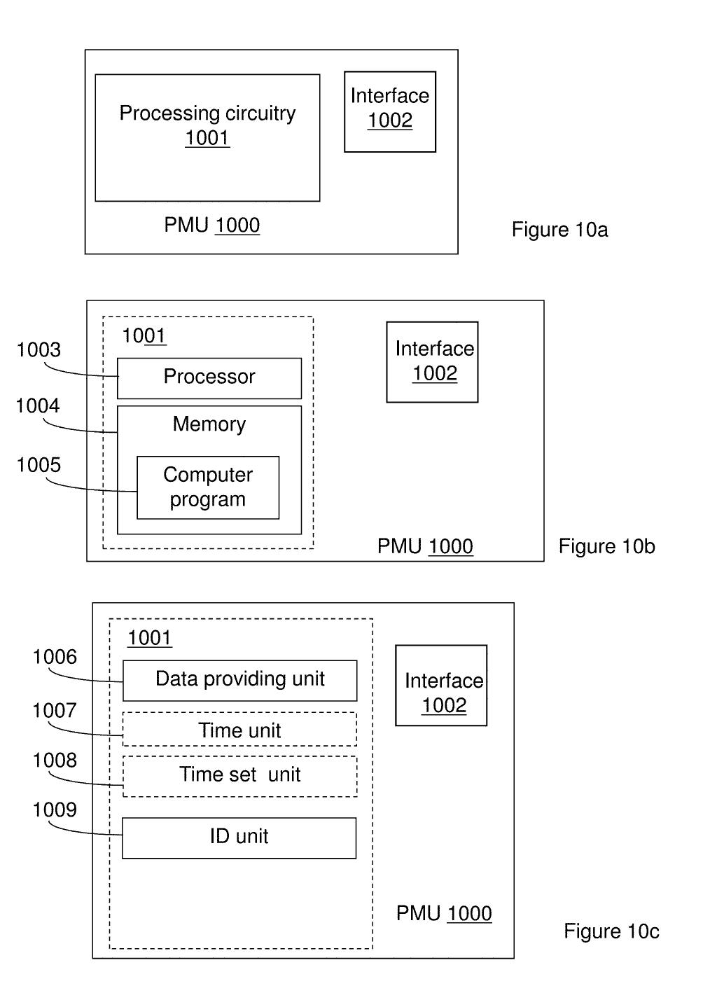

PMU, FIGS. 10a-10c

An exemplifying embodiment of a PMU comprised in the arrangement is illustrated in a general manner in FIG. 10a. The PMU 1000 is configured to perform the actions associated with a PMU of at least one of the method embodiments described above with reference to any of FIGS. 3-7. The PMU 1000 is associated with the same technical features, objects and advantages as the previously described method embodiments. The PMU will be described in brief in order to avoid unnecessary repetition.

The PMU may be implemented and/or described as follows:

The PMU 1000 comprises processing circuitry 1001 and a communication interface 1002. The processing circuitry 1001 is configured to cause the PMU 1000 to provide data related to a milking session of a specific dairy animal directly to a WUE 900 over a short-range wireless link. The processing circuitry 1001 may further be configured to cause the PMU to request, and receive, a time reference from the WUE. The communication interface 1002, which may also be denoted e.g. Input/Output (I/O) interface, includes an interface for sending data to and receiving data from WUEs.

FIG. 10b shows an embodiment of the processing circuitry 1001 which comprises a processing device 1003, such as a general-purpose microprocessor, e.g. a CPU, and a memory 1004, in communication with the processing device, that stores or holds instruction code readable and executable by the processing device. The instruction code stored or held in the memory may be in the form of a computer program 1005, which when executed by the processing device 1003 causes the PMU 1000 to perform the actions in the manner described above

An alternative implementation of the processing circuitry 1001 is shown in FIG. 10c. The processing circuitry here comprises a data providing unit 1006, for causing the PMU to provide data related to a milking session of a specific dairy animal directly to a WUE over a short-range wireless link. The processing circuitry may further comprise a time unit 1007 for causing the PMU to request and receive a time reference from the WUE 900. The processing circuitry could comprise more units, such as e.g. a time set unit 1008 for causing the PMU to calibrate a local clock unit based on a received time reference.

The PMUs described above could be configured for the different method embodiments described herein, e.g. in regard of what is comprised in the provided information.

The PMU 1000 may be assumed to comprise further functionality, for carrying out regular PMU functions.

The foregoing description of a PMU 1000 is not intended be limiting. The processing circuitry may also be implemented by other techniques known in the art, such as, e.g., hard-wired transistor logic or application-specific integrated circuits arranged in a manner sufficient to carry out the actions of the PMU 1000 as described above.

To summarize, the steps, functions, procedures, modules, units and/or blocks described herein may be implemented in hardware using any conventional technology, such as discrete circuit or integrated circuit technology, including both general-purpose electronic circuitry and application-specific circuitry. Alternatively, at least some of the steps, functions, procedures, modules, units and/or blocks described above may be implemented in software such as a computer program for execution by suitable processing circuitry including one or more processing units. The software could be carried by a carrier, such as an electronic signal, an optical signal, a radio signal, or a computer readable storage medium before and/or during the use of the computer program in the nodes.

The flow diagram or diagrams presented herein may be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

It should also be understood that it may be possible to re-use the general processing capabilities of any conventional device or unit in which the proposed technology is implemented. It may also be possible to re-use existing software, e.g. by reprogramming of the existing software or by adding new software components.

The embodiments described above are merely given as examples, and it should be understood that the proposed technology is not limited thereto. It will be understood by those skilled in the art that various modifications, combinations and changes may be made to the embodiments without departing from the present scope. In particular, different part solutions in the different embodiments can be combined in other configurations, where technically possible.

When using the word “comprise” or “comprising” it shall be interpreted as non-limiting, i.e. meaning “consist at least of”.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

### ABBREVIATIONS

AMS Automatic Milking System
PMU Portable Milking Unit
WUE Wireless User Equipment

1. A method performed by an arrangement comprising a Portable Milking Unit (PMU) operable to communicate using short-range wireless communication and a Wireless User Equipment (WMU) operable to communicate using short-range wireless communication, the method comprising:
the PMU providing (301) data related to a milking session of a specific dairy animal directly to the WUE over a short-range wireless link, said data including at least information indicative of a milk yield of the specific dairy animal during the milking session;
the WUE receiving (302) the data related to the milking session of the specific dairy animal directly from the PMU over the short-range wireless link;
the WUE storing (303) the received data in a memory;
the WUE retrieving (304) previously stored data related to one or more previous milking sessions; and
the WUE displaying a representation of the received data and the retrieved previously stored data on a display of the WUE.

2. The method according to claim 1, wherein the storing by the WUE of the received data in a memory further comprises providing (611) the received data to a remote server (601) for storage.

3. The method according to claim 1, further comprising:
the PMU requesting (506) a time reference from the WUE;
the WUE receiving (507) the request from the PMU for a time reference; and
the WUE providing (508), in response to the received request, a time reference derived from a local clock of the WUE, to the PMU;
the PMU receiving (509) the time reference provided from the WUE; and
the PMU including time information in the data provided to the WUE, the time information being based on the received time reference.

4. The method according claim 1, further comprising:
obtaining, by the WUE, from a remote server, reference data related to one or more geographically remote milking sessions;
displaying a representation of said obtained reference data on the display of the WUE as a reference enabling evaluation of the milking session in relation to the one or more geographically remote milking sessions.

5. The method according to claim 1, wherein the representation provided for display comprises coordinates comprising a milk yield value and a time value.

6. The method according to claim 1, wherein the data provided by the PMU and received by the WUE further comprises at least one of:
an identifier of the specific dairy animal;
an indicator of the amount of blood comprised in milk from the milking session;
an indicator of the conductivity of milk from the milking session;
time information related to the milking session;
information about a milk flow during the milking session.

7. The method according to claim 1, further comprising:
when an indicator comprised in, or derived from, the data received by the WUE is determined (403) to meet a threshold,
causing (404), at the WUE, an auditory, visual and/or tactile alarm signal to be presented by the WUE.

8. An arrangement for supporting dairy animal management, the arrangement comprising:
a Portable Milking Unit (PMU) operable to communicate using short-range wireless communication; and
a Wireless User Equipment (WMU) operable to communicate using short-range wireless communication, wherein:
the PMU is configured to provide data related to a milking session of a specific dairy animal directly to the WUE over a short-range wireless link, the data including at least information indicative of a milk yield of the specific dairy animal during the milking session,
the WUE is configured to receive the data related to a milking session of a specific dairy animal directly from the PMU over the short-range wireless link,
the WUE is configured to store the received data in a memory,
the WUE is configured to retrieve previously stored data related to one or more previous milking session, and
the WUE is configured to display a representation of the received data and the retrieved previously stored data on a display of the WUE.

9. The arrangement according to claim 8, wherein the storing, by the WUE, of the received data in a memory further comprises providing the received data to a remote server for storage.

10. The arrangement according to claim 8, wherein:
the PMU is further configured to request a time reference from the WUE,
the WUE is further configured to receive the request for a time reference from the PMU,
the WUE is further configured to provide, in response to the received request, a time reference derived from a local clock of the WUE, to the PMU,
the PMU is further configured to receive the time reference provided from the WUE, and
the PMU is further configured to include time information in the data provided to the WUE, based on the received time reference.

11. The arrangement according to claim 8, wherein the WUE is further configured to:
obtain, from a remote server, reference data related to one or more geographically remote milking sessions; and
provide a representation of said obtained reference data for display on the display of the WUE as a reference enabling evaluation of the milking session in relation to the one or more geographically remote milking sessions.

12. A non-transitory data recording medium having stored therein a computer program comprising instructions which, when executed on at least one processor, cause the at least one processor to carry out the method steps of the PMU in the method according to claim 1.

13. (canceled)

14. (canceled)

15. The method according to claim 2, further comprising:
the PMU requesting (506) a time reference from the WUE;
the WUE receiving (507) the request from the PMU for a time reference; and
the WUE providing (508), in response to the received request, a time reference derived from a local clock of the WUE, to the PMU;
the PMU receiving (509) the time reference provided from the WUE; and
the PMU including time information in the data provided to the WUE, the time information being based on the received time reference.

16. The method according claim 2, further comprising:
obtaining, by the WUE, from a remote server, reference data related to one or more geographically remote milking sessions;
displaying a representation of said obtained reference data on the display of the WUE as a reference enabling evaluation of the milking session in relation to the one or more geographically remote milking sessions.

17. The method according claim 3, further comprising:
obtaining, by the WUE, from a remote server, reference data related to one or more geographically remote milking sessions;
displaying a representation of said obtained reference data on the display of the WUE as a reference enabling evaluation of the milking session in relation to the one or more geographically remote milking sessions.

18. The method according to claim 2, wherein the representation provided for display comprises coordinates comprising a milk yield value and a time value.

19. The method according to claim 3, wherein the representation provided for display comprises coordinates comprising a milk yield value and a time value.

20. The method according to claim 4, wherein the representation provided for display comprises coordinates comprising a milk yield value and a time value.

21. The method according to claim 2, wherein the data provided by the PMU and received by the WUE further comprises at least one of:
an identifier of the specific dairy animal;
an indicator of the amount of blood comprised in milk from the milking session;
an indicator of the conductivity of milk from the milking session;
time information related to the milking session;
information about a milk flow during the milking session.

22. The method according to claim 3, wherein the data provided by the PMU and received by the WUE further comprises at least one of:
an identifier of the specific dairy animal;
an indicator of the amount of blood comprised in milk from the milking session;
an indicator of the conductivity of milk from the milking session;
time information related to the milking session;
information about a milk flow during the milking session.
